(19) United States
(12) Patent Application Publication
(10) Pub. No.: US 2025/0188240 A1
(43) Pub. Date: Jun. 12, 2025

(54) PROCESS FOR PRODUCING POROUS MATERIALS

(71) Applicant: aerogel-it GmbH, Osnabrueck (DE)

(72) Inventors: Raman Subrahmanyam, Osnabrueck (DE); Marc Fricke, Osnabrueck (DE); Dirk Weinrich, Osnabrueck (DE)

(73) Assignee: aerogel-it GmbH, Osnabrueck (DE)

(21) Appl. No.: 18/844,105

(22) PCT Filed: Mar. 8, 2023
(86) PCT No.: PCT/EP2023/055872

§ 371 Date: Sep. 5, 2024

(30) Foreign Application Priority Data
Mar. 8, 2022 (EP) 22160782.3
Mar. 8, 2022 (EP) 22160784.9

(51) Int. Cl. C08J 9/28; C08J 3/075; C08L 5/04; C08L 97/00

(52) U.S. Cl. CPC C08J 9/283; C08J 3/075; C08L 5/04; C08L 97/005; C08J 2201/0502; C08J 2205/026; C08J 2205/044; C08J 2305/04; C08J 2397/00; C08J 2405/04; C08J 2497/00

(57) ABSTRACT

A process for preparing a porous material provides a mixture (M1) of a water-soluble bio-based polyphenolic polymer and tannin biopolymers as compound (C1) and water. Mixture (M1) reacts with an aqueous solution of at least one polyvalent metal ion to prepare a gel (A), the gel (A) is exposed to a water-miscible solvent (L) to obtain a gel (B), and the gel (B) is dried. Porous materials which can be obtained in this process find application as thermal insulation material, carrier material for load and release of actives, batteries, electrode materials in batteries, fuels cells or electrolysis, for catalysis, for capacitors, for consumer electronics, for building and construction applications, for home and commercial appliance applications, for temperature-controlled logistics applications, for vacuum insulation applications, for apparel applications, for food applications, for cosmetic applications, for biomedical applications, for agricultural applications, for consumer applications, for packaging applications or for pharmaceutical applications.

The present invention relates to a process for preparing a porous material, at least comprising the steps of providing a mixture (M1) comprising a water-soluble bio-based polyphenolic polymer selected from the group consisting of lignin biopolymers and tannin biopolymers as compound (C1) and water; bringing mixture (M1) into contact with an aqueous solution of at least one polyvalent metal ion to prepare a gel (A), exposing the gel (A) obtained to a water-miscible solvent (L) to obtain a gel (B), and drying of the gel (B). The invention further relates to the porous materials which can be obtained in this way and the use of the porous materials as thermal insulation material, as carrier material for load and release of actives, for battery applications, for electrode materials in batteries, fuels cells or electrolysis, for catalysis, for capacitors, for consumer electronics, for building and construction applications, for home and commercial appliance applications, for temperature-controlled logistics applications, for vacuum insulation applications, for apparel applications, for food applications, for cosmetic applications, for biomedical applications, for agricultural applications, for consumer applications, for packaging applications or for pharmaceutical applications.

Porous materials based on bio-based polymers, for example polymer foams, having pores in the size range of a few microns or significantly below and a high porosity of at least 70% are particularly suitable for various applications.

Such porous materials having a small average pore diameter can be, for example, in the form of organic aerogels or xerogels which are produced with a sol-gel process and subsequent drying. In the sol-gel process, a sol based on an organic gel precursor is first produced and the sol is then gelled by means of a crosslinking step to form a gel. To obtain a porous material, for example an aerogel, from the gel, the liquid has to be removed. This step will hereinafter be referred to as drying in the interests of simplicity.

The present invention relates to a process for the manufacturing of porous materials containing bio-based phenolic polymers, as well as to the porous material as such and their use. In particular, the invention relates to a process for the manufacturing of lignin-containing porous materials. Lignin is a non-uniform biopolymer. Depending on its origin, for example the source of wood and/or plants as well as the extraction method, properties, such as molar mass or degree of condensation, and also the chemical composition may vary. Typically, lignin is a disordered biopolymer with three main building units, namely coumaryl alcohol, coniferyl alcohol and sinapyl alcohol. Other suitable bio-based phenolic polymers are for example tannins. Tannins, which may be natural products found in tree bark and other biological sources are high molecular polyphenolic compounds containing hydroxyls and other functional groups. There are several classes of tannins which typically differ in the base or monomer unit.

In principle, porous materials based on bio-based phenolic polymers are known from the state of the art, for example based on lignin and/or tannin or mixtures of lignin and other polymers. Preparation processes for lignin-based aerogels are also known from the state of the art.

In the scientific literature, several processes are disclosed. For example, an article in the Journal of Supercritical Fluids 2015, 105, 1-8 discloses a process for the preparation of hybrid alginate-lignin aerogels using pressurized carbon dioxide for gelation. Exposure of alginate and lignin aqueous alkali solution containing calcium carbonate to CO₂ resulted in a hydrogel formation.

U.S. Pat. No. 2,019,0329208A1 discloses methods for producing high-purity lignin-based carbon aerogels.

Highly porous organic aerogels based on tannin and lignin are disclosed in “New Tannin-Lignin Aerogels”, Grishechko, L. et al. Industrial Crops and Products 2013, 41347-355. Hydrogels are described, which are prepared at constant solid weight fraction and constant pH, but with different tannin/lignin and (tannin+lignin)/formaldehyde weight ratios.

Generally, organic molecules such as isocyanates or aldehydes are used as crosslinker. For many applications, these compounds are disadvantageous since they often are harmful and traces may remain in the materials obtained.

It was therefore an object of the invention to avoid the abovementioned disadvantages. It was one object of the present invention to provide a process for the preparation of porous materials based on polyphenolic polymers which avoids harmful materials. It was a further object of the present invention to provide porous materials which are suitable as thermal insulation material, as carrier material for load and release of actives, for battery applications, for electrode materials in batteries, fuels cells or electrolysis, for catalysis, for capacitors, for consumer electronics, for building and construction applications, for home appliance applications, for temperature-controlled logistics applications, for vacuum insulation applications, for apparel applications, for food applications, for cosmetic applications, for biomedical applications, for agricultural applications, for consumer applications, for packaging applications or for pharmaceutical application.

The porous materials should preferably have a high surface area. Furthermore, it was an object of the present invention to provide a process for preparing homogeneous gels and as a result homogeneous porous materials from bio-based polyphenolic polymers, such as for example lignin or tannin or mixtures thereof.

According to the present invention, this object is solved by a process for preparing a porous material, at least comprising the steps of:
a) providing a mixture (M1) comprising a water-soluble bio-based polyphenolic polymer selected from the group consisting of lignin biopolymers and tannin biopolymers as compound (C1) and water,
b) bringing mixture (M1) into contact with an aqueous solution of at least one polyvalent metal ion to prepare a gel (A)
c) exposing the gel (A) obtained in step b) to a water-miscible solvent (L) to obtain a gel (B),
d) drying of the gel (B) obtained in step c).

According to a further embodiment, the present invention is also directed to a process for preparing a porous material, at least comprising the steps of:
a) providing a mixture (M1) comprising a water-soluble bio-based polyphenolic polymer selected from the group consisting of lignin biopolymers and tannin biopolymers as compound (C1) and water,
b) bringing mixture (M1) into contact with an aqueous solution of at least one polyvalent metal ion to prepare a gel (A)
c) exposing the gel (A) obtained in step b) to a water-miscible solvent (L) to obtain a gel (B),
d) drying of the gel (B) obtained in step c).
   wherein the mixture (M1) further comprises at least one water-soluble polysaccharide with carboxylic acid groups as compound (C2).

According to the present invention, water-soluble bio-based polyphenolic polymers are used to form gels. Suitable phenolic polymers are in principle known from the state of the art. In the context of the present invention, lignin and tannin are preferably used as bio-based polymers due to the good availability of the starting materials. The use of lignin, tannin and/or their derivatives and/or mixtures thereof are especially attractive because of their stability, availability, renewability and low toxicity.

Furthermore, according to a further aspect of the present invention, bio-based polymers, and inorganic precursors, and polysaccharides with carboxylic acid groups are used to form gels. Suitable bio-based polymers, and inorganic precursors, and polysaccharides with carboxylic acid groups are in principle known from the state of the art. Suitable polysaccharides with carboxylic acid groups are for example alginates, pectin, modified cellulose, xanthan, hyaluronic acid or modified starch. The use of these bio-based polymers and polysaccharides and their derivatives are especially attractive because of their stability, availability, renewability and low toxicity. Suitable inorganic precursors in the context of the present invention have to be soluble or at least partially soluble in the mixture (M1) and have to solidify in the gelation step.

For the purposes of the present invention, a gel is a crosslinked system based on a polymer which is present in contact with a liquid (known as solvogel or lyogel), or with water as liquid (aquagel or hydrogel). Here, the polymer phase forms a continuous three-dimensional network.

In the context of the present invention, water-soluble means that the solubility in water is sufficient to form a solution which can be used for preparing a gel.

According to the present invention, a gel is formed from the water-soluble bio-based polyphenolic polymer and at least one polyvalent metal ion. In particular, a gel is formed from the components of mixture (M1) and at least one polyvalent metal ion. The components (C1) and (C2) used for the process of the present invention have to be suitable to allow the formation of a gel with the polyvalent metal ion, in particular have to have suitable functional groups. In particular, the polyphenolic polymer used for the process of the present invention has to be suitable to form a gel with the polyvalent metal ion, in particular has to have suitable functional groups.

It has surprisingly been found that the claimed method allows to produce aerogels, i.e. aerogels based on water-soluble bio-based polyphenolic polymer, with low solid content and a high surface area, preferably also a high pore volume and a small pore diameter. Properties of the aerogels can be customized by adjusting the composition of mixture (M1), the reaction conditions at the stage of the formation of the hydrogel (gel (A)), or during solvent exchange as well as in the drying step. According to the present invention, it is possible to influence the properties of the hydrogels and/or aerogels by varying the ratio of the components, as well as by controlling the parameters of step a) and/or step b), such as for example adjusting the pH value in step a), and also by introducing a wide range of organic and inorganic materials in the gel matrix.

According to the present invention, the water-soluble bio-based polyphenolic polymer preferably is selected from the group consisting of lignin biopolymers and tannin biopolymers, in particular selected from alkali lignin, Kraft lignin, hydrolytic lignin, soda lignin, aquasolv solid lignin, enzymatic lignin, lignin sulfonate, lignin carboxylate, lignin derivatives, biorefinery lignin, tannic acid, or tannin and tannin derivatives.

The mixture (M1) may comprise further components selected from the group consisting of water-soluble bio-based polyphenolic polymers and silica.

According to a further embodiment, the present invention also relates to a process as described above, wherein the water-soluble bio-based polyphenolic polymer is selected from lignin biopolymers and tannin biopolymers, in particular selected from alkali lignin, Kraft lignin, hydrolytic lignin, soda lignin, aquasolv solid lignin, enzymatic lignin, lignin sulfonate, lignin carboxylate, lignin derivatives, biorefinery lignin, tannic acid, or tannin and tannin derivatives.

Compound (C2) may be selected from the group consisting of alginates, pectin, modified cellulose, xanthan, hyaluronic acid or modified starch. Therefore, according to a further embodiment, the present invention is also directed to a process as described above, wherein compound (C2) may be selected from the group consisting of alginates, pectin, modified cellulose, xanthan, hyaluronic acid or modified starch, in particular from the group consisting of modified cellulose and alginates or from the group consisting of alginates.

According to the present invention, compound (C1) may for example be selected from the group consisting of lignin and tannin. Also, cellulose, bacterial cellulose, modified cellulose, starch, sugars, chitosan, polyhydroxyalkanoates, whey protein isolate, potato protein isolate, starch protein isolate, gelatine, collagen, casein or derivatives thereof, and silicates, titanates, vanadates, zirconates, aluminate, borates, ferrates, chromates, molybdates, tungstates, manganates, cobaltates and metal sulfides, metal oxides and metal carbides may be used in mixture (M1). According to a further embodiment, compound (C1) may for example be a mixture comprising compounds selected from the group consisting of lignin and tannin, cellulose, bacterial cellulose, modified cellulose, starch, sugars, chitosan, polyhydroxyalkanoates, whey protein isolate, potato protein isolate, starch protein isolate, gelatine, collagen, casein or derivatives thereof, and silicates, titanates, vanadates, zirconates aluminates, borates, ferrates, chromates, molybdates, tungstates, manganates, cobaltates and metal sulfides, metal oxides or metal carbides and compound (C2) may be an alginate or modified cellulose.

According to the present invention, the amount of the compounds (C1) and (C2) used in the process may vary, for example depending on the properties of the material to be achieved. In particular, the amount of the bio-based polyphenolic polymer used in the process may vary, for example depending on the properties of the material to be achieved.

Suitable amounts for compound (C1) are for example in the range of from of 0.1% by weight to 50% by weight based on the weight of mixture (M1), preferably in the range of from 1.0 to 40% by weight based on the weight of mixture (M1), in particular in the range of from 5.0 to 30% by weight based on the weight of mixture (M1).

According to a further embodiment, the present invention therefore also relates to a process as described above, wherein mixture (M1) comprises compound (C1) in an amount of 0.1% by weight to 50% by weight based on the weight of mixture (M1).

In case mixture (M1) comprises compound (C2), the ratio of compound (C1) and compound (C2) may also vary, depending on the compounds used. Typically, mixture (M1) comprises compound (C1) and compound (C2) in a ratio in the range of from 55:45 to 98:2, preferably in a range of from 60:40 to 95:5.

According to a further embodiment, the present invention therefore also relates to a process as described above, wherein mixture (M1) comprises compound (C1) and compound (C2) in a ratio in the range of from 55:45 to 98:2.

Furthermore, a wide range of organic and inorganic materials can be entrapped, i.e. physically or co-gelled in the matrix of the phenolic polymer, e.g. in the lignin matrix to achieve special properties. Furthermore, there are preferably no organic byproducts associated with the process.

In the context of the present invention, the pH value of the mixture (M1) may also vary depending on the compounds used. It has been found that advantageous results are obtained when the pH value of mixture (M1) is in the range of 8 to 14, in particular in the range of from 10 to 14, more preferable in the range of from 11 to 14.

According to a further embodiment, the present invention also relates to a process as described above, wherein the pH value of mixture (M1) is in the range of 8 to 14.

In the process according to the present invention, a mixture (M1) is provided according to step a). The mixture can be prepared by dissolving the desired amount of compounds (C1) and optionally (C2) in, e.g., distilled water. In the context of the present invention, it is also possible to adjust the pH value of the mixture to improve the solubility.

According to step b), mixture (M1) is brought into contact with an aqueous solution of a polyvalent metal ion to prepare a gel (A).

The aqueous solution of the polyvalent metal ion can for example be prepared using a salt of a polyvalent metal ion.

According to the present invention, polyvalent metal ions are suitable which form poorly soluble compounds with the bio-based polyphenolic polymer, in particular the lignin, used, i.e. which act as cross-linking metal ions. In particular, polyvalent metal ions are suitable which form poorly soluble compounds with the polysaccharide with carboxylic acid groups compound (C2), and can form poorly soluble compounds with compound (C1) used. Such polyvalent metal ions include, for example, alkaline earth metal ions and transition metal ions which form poorly soluble compounds with bio-based polyphenolic polymer. Alkaline earth metal ions, such as magnesium or calcium are preferred. Calcium is particularly preferred. Also trivalent metal ions such as aluminum or iron (III) are particularly suitable. Calcium salts are particularly preferred according to the invention for they are physiologically and, particularly, cosmetically acceptable and have a strong cross-linking and/or gelation effect compared to lignin. According to the present invention, also mixtures of two or more polyvalent ions may be used, for example mixtures comprising divalent and trivalent ions, such as mixtures comprising calcium and aluminum or mixtures comprising calcium and iron (III). In addition, e.g. beryllium, barium, strontium, zinc, cobalt, nickel, copper, manganese, iron, chromium, vanadium, titanium, zirconium, cadmium, molybdenum, tungsten, ruthenium, rhodium, iridium, palladium, platinum, aluminum can also be used.

The polyvalent metal ions preferably are added in the form of their salts. In principle, the corresponding anions can be selected arbitrarily provided they can be solubilized in water as is or by change of pH. Preferably, chlorides, acetates, nitrates-can be utilized, preferably calcium chloride or salts of trivalent metals such as iron (III) chloride, aluminum chloride or iron (III) nitrate or mixtures thereof.

The amount of the salt of the polyvalent metal ion is selected, so that the concentration of the salt in the resulting solution preferably is between about 1 to 20% by weight, preferably in the range of from 1 to 10% by weight, more preferable in the range of from 1 to 5% by weight, in particular in the range of from 2 to 3% by weight.

According to a further embodiment, the present invention also relates to a process as described above, wherein the polyvalent metal ion is a divalent metal ion, in particular a divalent metal ion selected from earth alkali metal ions.

According to the present invention, also mixtures of polyvalent metal ions can be used.

The mixture (M1) provided in step (a) can also comprise further salts, in particular such salts that do not form gels, and customary auxiliaries known to those skilled in the art as further constituents.

Furthermore, the mixture (M1) can comprise cosmetic or medically active substances.

According to a further embodiment, the present invention also relates to a process as described above, wherein a compound (C) is added to mixture (M1) in step a) which is suitable to form a gel. Compound (C) may be soluble or partially soluble in the mixture (M1). In the context of the present invention, it is also possible that compound (C) is insoluble in the mixture (I).

According to a further embodiment, the present invention also relates to a process as described above, wherein a compound (C) is added to mixture (M1) selected from pigments, opacifiers, flame retardants, metals, metal particles, metal nanoparticles, metal fibers, metal meshes, metal oxides, metal oxide particles, metal oxide nanoparticles, metal oxide fibers, metal salts, metals for catalysis, catalytic materials, metal carbide or metal sulfide particles or nanoparticles, silicon-based materials, silicon particles, silicon nanoparticles, semiconductor-based materials, semiconductor particles, semiconductor nanoparticles, semiconductor fibers, semiconductor meshes, carbon materials, carbon black, graphite nanoparticles, graphite fibers, graphite sheets, graphite meshes, graphene nanoparticles, graphene fibers, graphene sheets, graphene meshes, metal-organic frameworks, sulfur, inorganic and/or organic fillers, nucleating agents, stabilizers, heat control member, surface-active substances, fibers and foam reinforcement.

According to a further embodiment, the present invention also relates to a process as described above, wherein a water insoluble solid (S) is added to mixture (M1).

Solid (S) may for example be a porous material or foam, a carrier or a fibrous material. According to the present invention, it is also possible that mixture (M1) is present in the pores of a solid (S).

According to step b) of the present invention, mixture (M1) is brought into contact with an aqueous solution of a polyvalent metal ion to prepare a gel (A). Suitable mixing steps are in principle known to the person skilled in the art. It is for example possible to add mixture (M1) dropwise to the aqueous solution of the polyvalent metal ion. It is also possible that mixture (M1) is provided in the pores of a carrier material or in admixture with fibers before bringing it into contact with the aqueous solution of a polyvalent metal ion to prepare a gel (A). Also, mixture (M1) can be brought into contact with the polyvalent metal ion in an emulsion or in a spray process.

Gelling is known per se to a person skilled in the art and is described, for example, in WO 2009/027310 on page 21, line 19 to page 23, line 13.

Preferably, temperature and pressure in step b) are adjusted to conditions under which a gel is formed. A suitable temperature might be in the range of from 10 to 40° C., preferable in the range of from 15 to 35° C. According to a further embodiment, the present invention also relates to a process as described above, wherein step b) is carried out at a temperature in the range of from 10 to 40° C.

The rate of formation of the insoluble gel can be controlled very exactly and easily by choosing suitable conditions for step b).

Gel (A) obtained in step b) is a gel comprising water, i.e. a hydrogel. According to the present invention gel (A) obtained in step b) is exposed to a water-miscible solvent (L) to obtain a gel (B) in step c) of the process of the present invention.

However, it is also possible to use the hydrogel (A) obtained as an intermediate of the process as disclosed above as such. Many applications for hydrogels are known. The hydrogel (A) is particularly homogenous, and particles can be prepared according to the present invention which can be subjected to further process steps.

According to the present invention, a water-miscible solvent (L) is used in step c). In the context of the present invention, water-miscible means that the solvent is at least partially miscible with water in order to allow an exchange of solvent in the gel.

Solvent exchange is carried out either by soaking the gel directly in the new solvent (one-step) or by following a sequential soaking (multi-step) in different water-to-new solvent mixtures with increasing content in the new solvent after a certain time (exchange frequency) in the previous soaking step (Robitzer et al. Langmuir 2008, 24, 12547-12552). The solvent chosen for water replacement must satisfy the requirements of not dissolving the gel structure, being completely soluble with the solvent which precedes them (water) and preferably also accepted for manufacturing of pharmaceuticals. Furthermore, in case the process encompasses a step of supercritical drying, solvent (L) preferably is at least partially miscible with the supercritical medium.

The solvent (L) can in principle be any suitable compound or mixture of a plurality of compounds, which meets the above requirements with the solvent (L) being liquid under the temperature and pressure conditions of step c).

Possible solvents (L) are, for example, alcohols, ketones, aldehydes, alkyl alkanoates, organic carbonates, amides such as formamide and N-methylpyrollidone, sulfoxides such as dimethyl sulfoxide, aliphatic and cycloaliphatic halogenated or non-halogenated hydrocarbons, halogenated or non-halogenated aromatic compounds and fluorine-containing ethers. Mixtures of two or more of the abovementioned compounds are likewise possible.

In many cases, particularly suitable solvents (L) are obtained by using two or more completely miscible compounds selected from the abovementioned solvents.

Suitable solvents are in particular alcohols and ketones, for example C1 to C6 alcohols and C1 to C6 ketones and mixtures thereof.

According to a further embodiment, the present invention also relates to a process as described above, wherein the solvent (L) used in step c) is selected from the group consisting of C1 to C6 alcohols and C1 to C6 ketones and mixtures thereof.

Particularly suitable are alcohols such as methanol, ethanol and isopropanol and ketones such as acetone, and methyl ethyl ketone.

The solvent exchange according to step b) might be carried out in one step, 2 steps, 3 steps or in multiple steps with varying concentration of the solvent. According to a preferred embodiment, gels (A) are successively immersed in ethanol/water mixtures with concentrations of for example 30, 60, 90 and 100 wt % for 5 min to 12 h in each depending on the particle size and porosity. It is for example possible to carry out step b) in 2 or 3 steps using ethanol/water mixtures with concentrations in the range of more than 60% of ethanol in the first step and more than 90% of ethanol in the last step, for example more than 95% or more than 98% in the last step.

In step c), gel (B) is obtained. According to step d) of the process of the present invention, gel (B) obtained in step c) is dried.

Drying in step (d) takes place in a known manner. Drying under supercritical conditions is preferred, preferably after replacement of the solvent by CO₂ or other solvents suitable for the purposes of supercritical drying. Such drying is known per se to a person skilled in the art. Supercritical conditions characterize a temperature and a pressure at which CO₂ or any solvent used for removal of the gelation solvent is present in the supercritical state. In this way, shrinkage of the gel body on removal of the solvent can be reduced.

In the context of the present invention it is also possible to dry the gels obtained by conversion of the liquid comprised in the gel into the gaseous state at a temperature and a pressure below the critical temperature and the critical pressure of the liquid comprised in the gel.

According to one embodiment, the drying of the gel obtained is preferably carried out by converting the solvent (L) into the gaseous state at a temperature and a pressure below the critical temperature and the critical pressure of the solvent (L). Accordingly, drying is preferably carried out by removing the solvent (L) which was present in the reaction without prior replacement by a further solvent.

Such methods are likewise known to those skilled in the art and are described in WO 2009/027310 on page 26, line 22 to page 28, line 36.

According to a further embodiment, the present invention also relates to a process as described above, wherein the drying according to step d) is carried out by converting the liquid comprised in the gel into the gaseous state at a temperature and a pressure below the critical temperature and the critical pressure of the liquid comprised in the gel.

According to a further embodiment, the present invention also relates to a process as described above, wherein the drying according to step d) is carried out under supercritical conditions.

The process might also comprise one or more further modification steps such as a shaping step that may include fibers and/or adhesives and/or thermoplastic materials, a compression step, a lamination step, a post-drying, a hydrophobization step, or a carbonization step. It is for example possible to combine one or more of these steps, for example a post-drying and a hydrophobization step.

According to a further embodiment, the present invention also relates to a process as described above, wherein in the process comprises one or more further modification steps of the dried gel.

According to a further embodiment, the present invention also relates to a process as described above, wherein the modification step is selected from the group consisting of a shaping step, a compression step, a lamination step, a post-drying step, a hydrophobization step, and a carbonization step.

The present invention also relates to a porous material, which is obtained or obtainable by the process as described above. The porous materials of the present invention are preferably aerogels, cryogels or xerogels.

For the purposes of the present invention, a xerogel is a porous material which has been produced by a sol-gel process in which the liquid phase has been removed from the gel by drying below the critical temperature and below the critical pressure of the liquid phase (“subcritical conditions”). A cryogel is a porous material which is produced by freezing the solvent in the gel and removal of solid solvent through sublimation process at ambient conditions. An aerogel is a porous material which has been produced by a sol-gel process in which the liquid phase has been removed from the gel under supercritical conditions.

The process as disclosed above results in porous materials with improved properties. Aerogels produced according to the process of the present invention preferably have a low density, and preferably high specific surface area, for example in the range of from 120 to 800 m²/g or in the range of from 200 to 800 m²/g. Furthermore, a pore volume in the range of from 2.1 to 9.5 cm³/g for pore sizes <150 nm can preferably be obtained. Furthermore, a pore volume in the range of from 2.1 to 9.5 cm³/g for pore sizes <100 nm can preferably be obtained.

Furthermore, the present invention therefore is directed to a porous material which is obtained or obtainable by the process for preparing a porous material as disclosed above. In particular, the present invention is directed to a porous material which is obtained or obtainable by the process for preparing a porous material as disclosed above, wherein the drying according to step d) is carried out under supercritical conditions.

The porous material according to the invention preferably has a density in the range of 0.005 to 1 g/cm³, preferably from 0.01 to 0.5 g/cm³ (determined according to DIN 53420).

The average pore diameter is determined by scanning electron microscopy and subsequent image analysis using a statistically significant number of pores. Corresponding methods are known to those skilled in the art. For characterization of the porous structure of aerogels a Nova 3000 Surface Area Analyzer from Quantachrome Instruments was used. It uses adsorption and desorption of nitrogen at a constant temperature of 77 K.

The volume average pore diameter of the porous material is preferably not more than 1 micron. The volume average pore diameter of the porous material is particularly preferably not more than 750 nm, very particularly preferably not more than 500 nm and in particular not more than 250 nm. The volume average pore diameter of the porous material may for example be in a range of from 1 to 1000 nm, preferably in the range of from 2 to 500 nm, in particular in the range of from 3 to 250 nm, more preferable in the range of from 5 to 100 nm or particularly preferred in the range of from 10 to 50 nm.

The porous material which can be obtained according to the invention preferably has a porosity of at least 70% by volume, in particular from 70 to 99% by volume, particularly preferably at least 80% by volume, very particularly preferably at least 85% by volume, in particular from 85 to 95% by volume. The porosity in % by volume means that the specified proportion of the total volume of the porous material comprises pores. Although a very high porosity is usually desirable from the point of view of a minimal thermal conductivity, an upper limit is imposed on the porosity by the mechanical properties and the processability of the porous material.

According to a further embodiment, the present invention also relates to a porous material as disclosed above, wherein the specific surface area of the porous material is in the range of from 120 to 800 m²/g, determined using the BET theory according to DIN 66134:1998-0.

According to a further embodiment, the present invention also relates to a porous material as disclosed above, wherein the specific surface area of the porous material is in the range of from 120 to 800 m²/g, determined using the BET theory according to DIN 66134:1998-0 and the pore volume is in the range of from 2.1 to 9.5 cm³/g for pore sizes <150 nm.

It has been surprisingly found that according to the present invention, it is possible to obtain materials which have a very low content of volatile organic compounds even if the starting materials used may contain higher amounts of volatile organic compounds. For example, lignins often contain volatile organic compounds due to their preparation process such as for example guaiacol.

According to a further embodiment, the present invention therefore also relates to a porous material as disclosed above, wherein the content of volatile organic compounds (VOC) in the porous material is less than 50% of the content of volatile organic compounds (VOC) in the bio-based polyphenolic polymer used in the process.

The porous materials which can be obtained according to the invention preferably have a high porosity and a low density. In addition, the porous materials preferably have a small average pore size. The combination of the abovementioned properties allows the materials to be used as insulation material in the field of thermal insulation, in particular for applications in the ventilated state as building materials or in refrigerators, apparels, or batteries.

The present invention is also directed to the use of porous materials as disclosed above or a porous material obtained or obtainable according to a process as disclosed above as thermal insulation material or for vacuum insulation panels. The thermal insulation material is for example insulation material which is used for insulation in the interior or the exterior of a building. The porous material according to the present invention can advantageously be used in thermal insulation systems such as for example composite materials.

Furthermore, the present invention relates to the use of the porous materials according to the invention for battery applications, for electrode materials in batteries, fuels cells or electrolysis, for catalysis, for capacitors, for cosmetic applications, for biomedical applications, for pharmaceutical applications, for agricultural applications and also for the manufacture of a medical product. Such cosmetic applications include for example products for facial treatment such as skin scrubbing or cleansing or protective products such as products for UV protection or products including antioxidants.

According to a further aspect, the present invention relates to the use of porous materials as disclosed above or a porous material obtained or obtainable by the process as disclosed above as thermal insulation material, for cosmetic applications, for biomedical applications or for pharmaceutical applications. According to a further preferred aspect, the present invention relates to the use of porous materials as disclosed above or a porous material obtained or obtainable by the process as disclosed above as thermal insulation material, as carrier material for load and release of actives, for battery applications, for electrode materials in batteries, fuels cells or electrolysis, for catalysis, for capacitors, for consumer electronics, for building and construction applications, for home and commercial appliance applications, for temperature-controlled logistics applications, for vacuum insulation applications, for battery applications, for apparel applications, for food applications, for cosmetic applications, for biomedical applications, for agricultural applications, for consumer applications, for packaging applications or for pharmaceutical applications.

Preferred embodiments may be found in the claims and the description. Combinations of preferred embodiments do not go outside the scope of the present invention. Preferred embodiments of the components used are described below.

The present invention includes the following embodiments, wherein these include the specific combinations of embodiments as indicated by the respective interdependencies defined therein.
1. Process for preparing a porous material, at least comprising the steps of:
   a) providing a mixture (M1) comprising a water-soluble bio-based polyphenolic polymer and water,
   b) bringing mixture (M1) into contact with an aqueous solution of at least one polyvalent metal ion to prepare a gel (A)
   c) exposing the gel (A) obtained in step b) to a water-miscible solvent (L) to obtain a gel (B),
   d) drying of the gel (B) obtained in step c).
2. The process according to embodiment 1, wherein the water-soluble bio-based polyphenolic polymer is selected from the group consisting of lignin biopolymers and tannin biopolymers, in particular selected from the group consisting of alkali lignin, Kraft lignin, hydrolytic lignin, soda lignin, aquasolv solid lignin, enzymatic lignin, lignin sulfonate, lignin carboxylate, lignin derivatives, biorefinery lignin, tannic acid, or tannin and tannin derivatives
3. The process according to any of embodiments 1 or 2, wherein mixture (M1) comprises the bio-based polyphenolic polymer in an amount of 0.1% by weight to 50% by weight based on the weight of mixture (M1).
4. The process according to any of embodiments 1 to 3, wherein the pH value of mixture (M1) is in the range of 8 to 14.
5. The process according to any of embodiments 1 to 4, wherein the polyvalent metal ion is a divalent metal ion, in particular a divalent metal ion selected from the group consisting of earth alkali metal ions or wherein the polyvalent metal ion is a trivalent metal ion selected from the group consisting of aluminum ions and iron (III) ions.
6. The process according to any of embodiments 1 to 5, wherein the process comprises further modification steps of the dried gel.
7. The process according to embodiment 6, wherein the modification step is selected from the group consisting of a shaping step, a compression step, a lamination step, a post-drying step, a hydrophobization step, and a carbonization step.
8. The process according to any of embodiments 1 to 7, wherein the solvent (L) used in step c) is selected from the group consisting of C1 to C6 alcohols and C1 to C6 ketones and mixtures thereof.
9. The process according to any of embodiments 1 to 8, wherein a water insoluble solid(S) is added to mixture (M1).
10. The process according to any of embodiments 1 to 9, wherein a compound (C) is added to mixture (M1) selected from the group consisting of pigments, opacifiers, flame retardants, catalytic materials, metals, metal oxides, metal sulfides, metal carbides, metal salts, silicon-based materials, carbon-based materials, metal-organic frameworks, semiconductors, sulfur, fillers, surface-active substances, heat control member, fibers and foam reinforcement.
11. The process according to any of embodiments 1 to 10, wherein the drying according to step d) is carried out by converting the liquid comprised in the gel into the gaseous state at a temperature and a pressure below the critical temperature and the critical pressure of the liquid comprised in the gel.
12. The process according to any of embodiments 1 to 10, wherein the drying according to step d) is carried out under supercritical conditions.
13. A porous material, which is obtained or obtainable by the process according to any of embodiments 1 to 12.
14. The porous material according to embodiment 13, wherein the specific surface area of the porous material is in the range of from 120 to 800 m²/g or 200 to 800 m²/g, determined using the BET theory according to DIN 66134:1998-0 and the pore volume is in the range of from 2.1 to 9.5 cm³/g for pore sizes <150 nm.
15. The porous material according to embodiment 13 or 14, wherein the content of volatile organic compounds (VOC) in the porous material is less than 50% of the content of volatile organic compounds (VOC) in the bio based polyphenolic polymer used in the process.
16. The use of porous materials according to any of embodiments 13 to 15 or a porous material obtained or obtainable by the process according to any of embodiments 1 to 12 as thermal insulation material, as carrier material for load and release of actives, for battery applications, for electrode materials in batteries, fuels cells or electrolysis, for catalysis, for capacitors, for consumer electronics, for building and construction applications, for home appliance applications, for temperature-controlled logistics applications, for vacuum insulation applications, for apparel applications, for food applications, for cosmetic applications, for biomedical applications, for agricultural applications, for consumer applications, for packaging applications or for pharmaceutical application.
17. Process for preparing a porous material, at least comprising the steps of:
   a) providing a mixture (M1) comprising a water-soluble bio-based (poly) phenolic polymer selected from lignin biopolymers and water,
   b) bringing mixture (M1) into contact with an aqueous solution of at least one polyvalent metal ion to prepare a gel (A)
   c) exposing the gel (A) obtained in step b) to a water-miscible solvent (L) to obtain a gel (B),
   d) drying of the gel (B) obtained in step c).
18. The process according to embodiment 17, wherein the water-soluble bio-based polyphenolic polymer is selected from the group consisting of alkali lignin, Kraft lignin, hydrolytic lignin, soda lignin, aquasolv solid lignin, enzymatic lignin, lignin sulfonate, lignin carboxylate, lignin derivatives, biorefinery lignin.
19. The process according to any of embodiments 17 or 18, wherein mixture (M1) comprises the bio-based polyphenolic polymer in an amount of 0.1% by weight to 50% by weight based on the weight of mixture (M1).
20. The process according to any of embodiments 17 to 19, wherein the pH value of mixture (M1) is in the range of 8 to 14.
21. The process according to any of embodiments 17 to 20, wherein the polyvalent metal ion is a divalent metal ion, in particular a divalent metal ion selected from the group consisting of earth alkali metal ions or wherein the polyvalent metal ion is a trivalent metal ion selected from the group consisting of aluminum ions and iron (III) ions.
22. The process according to any of embodiments 17 to 21, wherein the process comprises further modification steps of the dried gel.
23. The process according to embodiment 22, wherein the modification step is selected from the group consisting of a shaping step, a compression step, a lamination step, a post-drying step, a hydrophobization step, and a carbonization step.
24. The process according to any of embodiments 17 to 23, wherein the solvent (L) used in step c) is selected from the group consisting of C1 to C6 alcohols and C1 to C6 ketones and mixtures thereof.
25. The process according to any of embodiments 17 to 24, wherein a water insoluble solid (S) is added to mixture (M1).
26. The process according to any of embodiments 17 to 25, wherein a compound (C) is added to mixture (M1) selected from the group consisting of pigments, opacifiers, flame retardants, catalytic materials, metals, metal oxides, metal sulfides, metal carbides, metal salts, silicon-based materials, carbon-based materials, metal-organic frameworks, semiconductors, sulfur, fillers, surface-active substances, heat control member, fibers and foam reinforcement.
27. The process according to any of embodiments 17 to 26, wherein the drying according to step d) is carried out by converting the liquid comprised in the gel into the gaseous state at a temperature and a pressure below the critical temperature and the critical pressure of the liquid comprised in the gel.
28. The process according to any of embodiments 17 to 26, wherein the drying according to step d) is carried out under supercritical conditions.
29. A porous material, which is obtained or obtainable by the process according to any of embodiments 17 to 28.
30. The porous material according to embodiment 29, wherein the specific surface area of the porous material is in the range of from 120 to 800 m²/g or 200 to 800 m²/g, determined using the BET theory according to DIN 66134:1998-0 and the pore volume is in the range of from 2.1 to 9.5 cm³/g for pore sizes <150 nm.
31. The porous material according to embodiment 29 or 30, wherein the content of volatile organic compounds (VOC) in the porous material is less than 50% of the content of volatile organic compounds (VOC) in the bio based polyphenolic polymer used in the process.
32. The use of porous materials according to any of embodiments 29 to 31 or a porous material obtained or obtainable by the process according to any of embodiments 17 to 28 as thermal insulation material, as carrier material for load and release of actives, for battery applications, for electrode materials in batteries, fuels cells or electrolysis, for catalysis, for capacitors, for consumer electronics, for building and construction applications, for home appliance applications, for temperature-controlled logistics applications, for vacuum insulation applications, for apparel applications, for food applications, for cosmetic applications, for biomedical applications, for agricultural applications, for consumer applications, for packaging applications or for pharmaceutical application.
33. Process for preparing a porous material, at least comprising the steps of:
   a) providing a mixture (M1) comprising a water-soluble bio-based (poly) phenolic polymer selected from the group consisting of lignin biopolymers and water,
   b) bringing mixture (M1) into contact with an aqueous solution of at least one polyvalent metal ion to prepare a gel (A), wherein the polyvalent metal ion is a divalent metal ion,
   c) exposing the gel (A) obtained in step b) to a water-miscible solvent (L) to obtain a gel (B),
   d) drying of the gel (B) obtained in step c).
34. The process according to embodiment 33, wherein the water-soluble bio-based polyphenolic polymer is selected from the group consisting of alkali lignin, Kraft lignin, hydrolytic lignin, soda lignin, aquasolv solid lignin, enzymatic lignin, lignin sulfonate, lignin carboxylate, lignin derivatives, biorefinery lignin.
35. The process according to any of embodiments 33 or 34, wherein mixture (M1) comprises the bio-based polyphenolic polymer in an amount of 0.1% by weight to 50% by weight based on the weight of mixture (M1).
36. The process according to any of embodiments 33 to 35, wherein the pH value of mixture (M1) is in the range of 8 to 14.
37. The process according to any of embodiments 33 to 36, wherein the polyvalent metal ion is a divalent metal ion selected from the group consisting of earth alkali metal ions or wherein the polyvalent metal ion is a trivalent metal ion selected from the group consisting of aluminum ions and iron (III) ions.
38. The process according to any of embodiments 33 to 37, wherein the process comprises further modification steps of the dried gel.
39. The process according to embodiment 38, wherein the modification step is selected from the group consisting of a shaping step, a compression step, a lamination step, a post-drying step, a hydrophobization step, and a carbonization step.
40. The process according to any of embodiments 33 to 39, wherein the solvent (L) used in step c) is selected from the group consisting of C1 to C6 alcohols and C1 to C6 ketones and mixtures thereof.
41. The process according to any of embodiments 33 to 40, wherein a water insoluble solid (S) is added to mixture (M1).
42. The process according to any of embodiments 33 to 41, wherein a compound (C) is added to mixture (M1) selected from the group consisting of pigments, opacifiers, flame retardants, catalytic materials, metals, metal oxides, metal sulfides, metal carbides, metal salts, silicon-based materials, carbon-based materials, metal-organic frameworks, semiconductors, sulfur, fillers, surface-active substances, heat control member, fibers and foam reinforcement.
43. The process according to any of embodiments 33 to 42, wherein the drying according to step d) is carried out by converting the liquid comprised in the gel into the gaseous state at a temperature and a pressure below the critical temperature and the critical pressure of the liquid comprised in the gel.
44. The process according to any of embodiments 33 to 42, wherein the drying according to step d) is carried out under supercritical conditions.
45. A porous material, which is obtained or obtainable by the process according to any of embodiments 33 to 44.
46. The porous material according to embodiment 45, wherein the specific surface area of the porous material is in the range of from 120 to 800 m²/g or 200 to 800 m²/g, determined using the BET theory according to DIN 66134:1998-0 and the pore volume is in the range of from 2.1 to 9.5 cm³/g for pore sizes <150 nm.
47. The porous material according to embodiment 45 or 46, wherein the content of volatile organic compounds (VOC) in the porous material is less than 50% of the content of volatile organic compounds (VOC) in the bio-based polyphenolic polymer used in the process.
48. The use of porous materials according to any of embodiments 45 to 47 or a porous material obtained or obtainable by the process according to any of embodiments 33 to 44 as thermal insulation material, as carrier material for load and release of actives, for battery applications, for electrode materials in batteries, fuels cells or electrolysis, for catalysis, for capacitors, for consumer electronics, for building and construction applications, for home appliance applications, for temperature-controlled logistics applications, for vacuum insulation applications, for apparel applications, for food applications, for cosmetic applications, for biomedical applications, for agricultural applications, for consumer applications, for packaging applications or for pharmaceutical application.
49. Process for preparing a porous material, at least comprising the steps of:
   a) providing a mixture (M1) comprising a water-soluble bio-based polyphenolic polymer selected from the group consisting of lignin biopolymers and tannin biopolymers as compound (C1) and water,
   b) bringing mixture (M1) into contact with an aqueous solution of at least one divalent metal ion to prepare a gel (A)
   c) exposing the gel (A) obtained in step b) to a water-miscible solvent (L) to obtain a gel (B),
   d) drying of the gel (B) obtained in step c).
50. Process for preparing a porous material, at least comprising the steps of:
   a) providing a mixture (M1) comprising a water-soluble bio-based polyphenolic polymer selected from the group consisting of lignin biopolymers and tannin biopolymers as compound (C1) and water,
   b) bringing mixture (M1) into contact with an aqueous solution of at least one divalent metal ion to prepare a gel (A)
   c) exposing the gel (A) obtained in step b) to a water-miscible solvent (L) to obtain a gel (B),
   d) drying of the gel (B) obtained in step c),
      wherein the mixture (M1) further comprises at least one water-soluble polysaccharide with carboxylic acid groups as compound (C2).
51. Process for preparing a porous material, at least comprising the steps of:
   a) providing a mixture (M1) comprising at least one compound (C1) selected from the group consisting of water-soluble bio-based polymers and inorganic precursors and at least one water-soluble polysaccharide with carboxylic acid groups as component (C2) and water,
   b) bringing mixture (M1) into contact with an aqueous solution of a polyvalent metal ion to prepare a gel (A)
   c) exposing the gel (A) obtained in step b) to a water miscible solvent (L) to obtain a gel (B),
   d) drying of the gel (B) obtained in step c).
52. The process according to embodiment 51, wherein compound (C1) is selected from the group consisting of water-soluble bio-based polyphenolic polymers and silica.
53. The process according to any of embodiments 51 or 52, wherein mixture (M1) comprises compound (C1) in an amount of 0.1% by weight to 50% by weight based on the weight of mixture (M1).
54. The process according to any of embodiments 51 to 53, wherein mixture (M1) comprises compound (C1) and compound (C2) in a ratio in the range of from 55:45 to 98:2.
55. The process according to any of embodiments 51 to 54, wherein the pH value of mixture (M1) is in the range of 8 to 14.
56. The process according to any of embodiments 51 to 55, wherein the polyvalent metal ion is a divalent metal ion, in particular a divalent metal ion selected from the group consisting of earth alkali metal ions or wherein the polyvalent metal ion is a trivalent metal ion selected from the group consisting of aluminum ions and iron (III) ions.
57. The process according to any of embodiments 51 to 56, wherein the process comprises one or more further modification steps of the dried gel, in particular wherein the modification step is selected from the group consisting of a shaping step, a compression step, a lamination step, a post-drying step, a hydrophobization step, and a carbonization step.
58. The process according to any of embodiments 51 to 57, wherein the solvent (L) used in step c) is selected from the group consisting of C1 to C6 alcohols and C1 to C6 ketones and mixtures thereof.
59. The process according to any of embodiments 51 to 58, wherein a water insoluble solid (S) is brought into contact with mixture (M1).
60. The process according to any of embodiments 51 to 59, wherein a compound (C) is added to mixture (M1) selected from the group consisting of pigments, opacifiers, flame retardants, catalytic materials, metals, metal oxides, metal sulfides, metal carbides, metal salts, silicon-based materials, carbon-based materials, metal-organic frameworks, semiconductors, sulfur, fillers, surface-active substances, heat control member, fibers and foam reinforcement.
61. The process according to any of embodiments 51 to 60, wherein the drying according to step d) is carried out by converting the liquid comprised in the gel into the gaseous state at a temperature and a pressure below the critical temperature and the critical pressure of the liquid comprised in the gel.
62. The process according to any of embodiments 51 to 60, wherein the drying according to step d) is carried out under supercritical conditions.
63. A porous material, which is obtained or obtainable by the process according to any of embodiments 51 to 62.
64. The porous material according to embodiment 63, wherein the specific surface area of the porous material is in the range of from 120 to 800 m²/g or 200 to 800 m²/g, determined using the BET theory according to DIN 66134:1998-0 and the pore volume is in the range of from 2.1 to 9.5 cm³/g for pore sizes <150 nm.
65. The porous material according to embodiment 63 or 64, wherein the content of volatile organic compounds (VOC) in the porous material is less than 50% of the content of volatile organic compounds (VOC) in the starting materials used in the process.
66. The use of porous materials according to any of embodiments 63 to 65 or a porous material obtained or obtainable by the process according to any of embodiments 51 to 62 as thermal insulation material, as carrier material for load and release of actives, for battery applications, for electrode materials in batteries, fuels cells or electrolysis, for catalysis, for capacitors, for consumer electronics, for building and construction applications, for home appliance applications, for temperature-controlled logistics applications, for vacuum insulation applications, for apparel applications, for food applications, for cosmetic applications, for biomedical applications, for agricultural applications, for consumer applications, for packaging applications or for pharmaceutical application.
67. Process for preparing a porous material, at least comprising the steps of:
   a) providing a mixture (M1) comprising at least one compound (C1) selected from the group consisting of water-soluble bio-based polyphenolic polymers and silica and at least one water-soluble polysaccharide with carboxylic acid groups as component (C2) and water,
   b) bringing mixture (M1) into contact with an aqueous solution of a polyvalent metal ion to prepare a gel (A)
   c) exposing the gel (A) obtained in step b) to a water miscible solvent (L) to obtain a gel (B),
   d) drying of the gel (B) obtained in step c).
68. The process according to embodiment 67, wherein compound (C1) is selected from the group consisting of lignin biopolymers and silica.
69. The process according to any of embodiments 67 or 68, wherein mixture (M1) comprises compound (C1) in an amount of 0.1% by weight to 50% by weight based on the weight of mixture (M1).
70. The process according to any of embodiments 67 to 69, wherein mixture (M1) comprises compound (C1) and compound (C2) in a ratio in the range of from 55:45 to 98:2.
71. The process according to any of embodiments 67 to 70, wherein the pH value of mixture (M1) is in the range of 8 to 14.
72. The process according to any of embodiments 67 to 71, wherein the polyvalent metal ion is a divalent metal ion, in particular a divalent metal ion selected from the group consisting of earth alkali metal ions or wherein the polyvalent metal ion is a trivalent metal ion selected from the group consisting of aluminum ions and iron (III) ions.
73. The process according to any of embodiments 67 to 722, wherein the process comprises one or more further modification steps of the dried gel, in particular wherein the modification step is selected from the group consisting of a shaping step, a compression step, a lamination step, a post-drying step, a hydrophobization step, and a carbonization step.
74. The process according to any of embodiments 67 to 73, wherein the solvent (L) used in step c) is selected from the group consisting of C1 to C6 alcohols and C1 to C6 ketones and mixtures thereof.
75. The process according to any of embodiments 67 to 74, wherein a water insoluble solid(S) is brought into contact with mixture (M1).
76. The process according to any of embodiments 67 to 75, wherein a compound (C) is added to mixture (M1) selected from the group consisting of pigments, opacifiers, flame retardants, catalytic materials, metals, metal oxides, metal sulfides, metal carbides, metal salts, silicon-based materials, carbon-based materials, metal-organic frameworks, semiconductors, sulfur, fillers, surface-active substances, heat control member, fibers and foam reinforcement.
77. The process according to any of embodiments 27 to 76, wherein the drying according to step d) is carried out by converting the liquid comprised in the gel into the gaseous state at a temperature and a pressure below the critical temperature and the critical pressure of the liquid comprised in the gel.
78. The process according to any of embodiments 27 to 76, wherein the drying according to step d) is carried out under supercritical conditions.
79. A porous material, which is obtained or obtainable by the process according to any of embodiments 27 to 78.
80. The porous material according to embodiment 79, wherein the specific surface area of the porous material is in the range of from 120 to 800 m²/g or 200 to 800 m²/g, determined using the BET theory according to DIN 66134:1998-0 and the pore volume is in the range of from 2.1 to 9.5 cm³/g for pore sizes <150 nm.
81. The porous material according to embodiment 79 or 80, wherein the content of volatile organic compounds (VOC) in the porous material is less than 50% of the content of volatile organic compounds (VOC) in the starting materials used in the process.
82. The use of porous materials according to any of embodiments 79 to 81 or a porous material obtained or obtainable by the process according to any of embodiments 67 to 78 as thermal insulation material, as carrier material for load and release of actives, for battery applications, for electrode materials in batteries, fuels cells or electrolysis, for catalysis, for capacitors, for consumer electronics, for building and construction applications, for home appliance applications, for temperature-controlled logistics applications, for vacuum insulation applications, for apparel applications, for food applications, for cosmetic applications, for biomedical applications, for agricultural applications, for consumer applications, for packaging applications or for pharmaceutical application.
83. Process for preparing a porous material, at least comprising the steps of:
   a) providing a mixture (M1) comprising at least one compound (C1) selected from the group consisting of water-soluble lignin biopolymers and silica and at least one water-soluble polysaccharide with carboxylic acid groups as component (C2) and water,
   b) bringing mixture (M1) into contact with an aqueous solution of a polyvalent metal ion to prepare a gel (A)
   c) exposing the gel (A) obtained in step b) to a water miscible solvent (L) to obtain a gel (B),
   d) drying of the gel (B) obtained in step c),
      wherein compound (C2) is selected from the group consisting of alginates, pectin, modified cellulose, xanthan, hyaluronic acid or modified starch.
84. The process according to embodiment 83, wherein compound (C2) is selected from the group consisting of alginates.
85. The process according to any of embodiments 83 or 84, wherein mixture (M1) comprises compound (C1) in an amount of 0.1% by weight to 50% by weight based on the weight of mixture (M1).
86. The process according to any of embodiments 83 to 85, wherein mixture (M1) comprises compound (C1) and compound (C2) in a ratio in the range of from 55:45 to 98:2.
87. The process according to any of embodiments 83 to 86, wherein the pH value of mixture (M1) is in the range of 8 to 14.
88. The process according to any of embodiments 83 to 87, wherein the polyvalent metal ion is a divalent metal ion, in particular a divalent metal ion selected from the group consisting of earth alkali metal ions or wherein the polyvalent metal ion is a trivalent metal ion selected from the group consisting of aluminum ions and iron (III) ions.
89. The process according to any of embodiments 83 to 88, wherein the process comprises one or more further modification steps of the dried gel, in particular wherein the modification step is selected from the group consisting of a shaping step, a compression step, a lamination step, a post-drying step, a hydrophobization step, and a carbonization step.
90. The process according to any of embodiments 83 to 89, wherein the solvent (L) used in step c) is selected from the group consisting of C1 to C6 alcohols and C1 to C6 ketones and mixtures thereof.
91. The process according to any of embodiments 83 to 90, wherein a water insoluble solid(S) is brought into contact with mixture (M1).
92. The process according to any of embodiments 83 to 91, wherein a compound (C) is added to mixture (M1) selected from the group consisting of pigments, opacifiers, flame retardants, catalytic materials, metals, metal oxides, metal sulfides, metal carbides, metal salts, silicon-based materials, carbon-based materials, metal-organic frameworks, semiconductors, sulfur, fillers, surface-active substances, heat control member, fibers and foam reinforcement.
93. The process according to any of embodiments 83 to 92, wherein the drying according to step d) is carried out by converting the liquid comprised in the gel into the gaseous state at a temperature and a pressure below the critical temperature and the critical pressure of the liquid comprised in the gel.
94. The process according to any of embodiments 83 to 92, wherein the drying according to step d) is carried out under supercritical conditions.
95. A porous material, which is obtained or obtainable by the process according to any of embodiments 83 to 94.
96. The porous material according to embodiment 95, wherein the specific surface area of the porous material is in the range of from 120 to 800 m²/g or 200 to 800 m²/g, determined using the BET theory according to DIN 66134:1998-0 and the pore volume is in the range of from 2.1 to 9.5 cm³/g for pore sizes <150 nm.
97. The porous material according to embodiment 95 or 96, wherein the content of volatile organic compounds (VOC) in the porous material is less than 50% of the content of volatile organic compounds (VOC) in the starting materials used in the process.
98. The use of porous materials according to any of embodiments 95 to 97 or a porous material obtained or obtainable by the process according to any of embodiments 83 to 94 as thermal insulation material, as carrier material for load and release of actives, for battery applications, for electrode materials in batteries, fuels cells or electrolysis, for catalysis, for capacitors, for consumer electronics, for building and construction applications, for home appliance applications, for temperature-controlled logistics applications, for vacuum insulation applications, for apparel applications, for food applications, for cosmetic applications, for biomedical applications, for agricultural applications, for consumer applications, for packaging applications or for pharmaceutical application.
99. Process for preparing a porous material, at least comprising the steps of:
   a) providing a mixture (M1) comprising at least one compound (C1) selected from the group consisting of lignin biopolymers and silica and at least one water-soluble polysaccharide with carboxylic acid groups as component (C2) and water,
   b) bringing mixture (M1) into contact with an aqueous solution of a divalent or trivalent metal ion to prepare a gel (A)
   c) exposing the gel (A) obtained in step b) to a water miscible solvent (L) to obtain a gel (B),
   d) drying of the gel (B) obtained in step c),
      wherein compound (C2) is selected from the group consisting of alginates, pectin, modified cellulose, xanthan, hyaluronic acid or modified starch.
100. Process for preparing a porous material, at least comprising the steps of:
   a) providing a mixture (M1) comprising water, at least one compound (C1) selected from the group consisting of lignin biopolymers and silica and at least one component (C2) selected from the group consisting of alginates,
   b) bringing mixture (M1) into contact with an aqueous solution of a divalent or trivalent metal ion to prepare a gel (A)
   c) exposing the gel (A) obtained in step b) to a water miscible solvent (L) to obtain a gel (B),
   d) drying of the gel (B) obtained in step c).

Examples will be used below to illustrate the invention.

### EXAMPLES

### 1. Materials Used

Materials: Kraft lignin (UPM), sodium hydroxide (NaOH, Sigma Aldrich), calcium chloride (CaCl₂, Sigma Aldrich), pure ethanol (Carl Roth), sodium alginate (Hydagen, BASF), hexamethyldisilazane (HMDZ, Sigma Aldrich), Ludox SM30 (Sigma Aldrich), whey protein (Agropure Ingredients), xanthan (Sigma Aldrich), microcrystalline cellulose (MCC, Sigma Aldrich), sodium caseinate (Sigma Aldrich), tannic acid (Sigma Aldrich), potato starch (Sigma Aldrich), gelatin (Sigma Aldrich).

### 2. Preparation Examples

### 2.1 Hydrophilic Lignin Aerogel from Kraft lignin—Ca Gelation

Solution 1: Kraft lignin powder (˜6000 g/mol, UPM) was dispersed in deionized water (20 wt. %) at room temperature, and 5 wt. % NaOH was added until a pH of 11.5 was obtained. After one day, the pH was measured and further 5 wt. % NaOH was added until a pH of 11.5.
Solution 2: Aqueous CaCl₂ (20 g/L) was prepared at room temperature.
Solution 1 was dropped into solution 2 (10× volume) with a pipette. Small hydrogel particles formed and settled to the bottom of solution 2.

The hydrogel particles were filtered through a 125 μm sieve.

The hydrogel particles were immersed in ethanol (93%) for 5 min. A final solvent exchange step was performed by immersing the hydrogel particles from the previous step in pure ethanol for 5 min to obtain alcogel particles (final solvent concentration 94-98%)

The alcogel particles were dried with supercritical carbon dioxide at 60° C., 120 bar, 1 h to obtain lignin aerogel particles. The aerogel particles do not smell of the original Kraft lignin raw material.
Surface area: 297 m²/g
Pore volume: 2.4 cm³/g
BJH pore diameter: 12 nm
Aerogel density: 200-300 g/l
Contact angle: 0°

### 2.2 Hydrophilic Lignin Aerogel from Kraft Lignin—Zn Gelation

Solution 1: Kraft lignin powder (˜6000 g/mol, UPM) was dispersed in deionized water (10 wt. %) at room temperature, and 5 wt. % NaOH was added until a pH of 11 was obtained. After one day, the pH was measured and further 5 wt. % NaOH was added until a pH of 11.
Solution 2: Aqueous ZnCl₂ (10 g/L) was prepared at room temperature.

Solution 1 was dropped into solution 2 (10× volume) with a pipette. Small hydrogel particles formed and settled to the bottom of solution 2.

The hydrogel particles were immersed in ethanol (93%, 10× volume) for 5 min. A final solvent exchange step was performed by immersing the gel particles from the previous step in pure ethanol (10× volume) for 5 min to obtain alcogel particles (final solvent concentration 94-98%).

The alcogel particles were dried with supercritical carbon dioxide at 60° C., 120 bar, 1 h to obtain lignin aerogel particles.

Bulk density of the lignin aerogel particles 5 was 80-120 g/l.

Surface area and pore volume of the lignin aerogel particles was determined to be 308 m²/g.

### 2.3 Hydrophilic Lignin Aerogel From Kraft Lignin—Sr Gelation

Solution 1: Kraft lignin powder (˜6000 g/mol, UPM) was dispersed in deionized water (20 wt. %) at room temperature, and 5 wt. % NaOH was added until a pH of 11 was obtained. After one day, the pH was measured and further 5 wt. % NaOH was added until a pH of 10.5.
Solution 2: Aqueous SrCl₂ (10 g/L) was prepared at room temperature (pH 7.8).

Solution 1 was dropped into solution 2 (10× volume) with a pipette. Small hydrogel particles formed and settled to the bottom of solution 2.

The hydrogel particles were immersed in ethanol (93%, 10× volume) for 5 min. A final solvent exchange step was performed by immersing the gel particles from the previous step in pure ethanol (10× volume) for 5 min to obtain alcogel particles (final solvent concentration 94-98%).

The alcogel particles were dried with supercritical carbon dioxide at 60° C., 120 bar, 1 h to obtain lignin aerogel particles.

Bulk density of the aerogel particles was 160-200 g/l.

Surface area of the aerogel particles was determined to be 273 m²/g.

### 2.4 Hydrophilic Lignin Aerogel From Biorefinery Lignin

Solution 1: Biorefinery lignin powder was dispersed in deionized water (20 wt. %) at room temperature, and 5 wt. % NaOH was added until a pH of 10.4 was obtained. After one day, the pH was measured and further 5 wt. % NaOH was added until a pH of 10.5.
Solution 2: Aqueous CaCl₂ (10 g/L) was prepared at room temperature.

Solution 1 was dropped into solution 2 (10× volume) with a pipette. Hydrogel particles formed and settled to the bottom of solution 2.

The hydrogel particles were immersed in ethanol (93%, 10× volume) for 5 min. A final solvent exchange step was performed by immersing the gel particles from the previous step in pure ethanol (10× volume) for 5 min to obtain alcogel particles (final solvent concentration 94-98%).

The alcogel particles were dried with supercritical carbon dioxide at 60° C., 120 bar, 1 h to obtain lignin aerogel particles.

Surface area of the aerogel particles was determined to be 151 m²/g.

### 3. Preparation Examples—Hybrid Materials

### 3.1 Hydrophilic Kraft Lignin/Alginate Hybrid Aerogel

Solution 1: Kraft lignin powder was dispersed in deionized water (14 wt. %) at room temperature, and 5 wt. % NaOH was added until a pH of 10 was obtained. Sodium alginate was added and dissolved to obtain a weight ratio of Kraft lignin and alginate of 92:8.
Solution 2: Aqueous CaCl₂ (10 g/L) was prepared at room temperature and adjusted to pH10 with 1M NaOH.

Solution 1 was dropped into solution 2 (10× volume) with a pipette. Hydrogel particles formed and settled to the bottom of solution 2.

The hydrogel particles were immersed in ethanol (93%, 10× volume) for 5 min. A final solvent exchange step was performed by immersing the gel particles from the previous step in pure ethanol (10× volume) for 5 min to obtain alcogel particles (final solvent concentration 94-98%).

The alcogel particles were dried with supercritical carbon dioxide at 60° C., 120 bar, 1h to obtain Kraft lignin/alginate hybrid aerogel particles.

Bulk density of the aerogel particles was ˜120 g/l.

Surface area and pore volume of the aerogel particles was determined to be 255 m²/g and 1.88 cm³/g.

### 3.2 Hydrophilic Kraft Lignin/Alginate Hybrid Aerogel—Various Ratios

Solution 1: Kraft lignin powder (was dispersed in deionized water (10 wt. %) at room temperature, and 5 wt. % NaOH was added until a pH of 11 was obtained. After one day, the pH was measured and further 5 wt. % NaOH was added until a pH of 11.
Solution 2: Sodium alginate was dissolved in water at room temperature at 2 wt %.
Solution 3: Aqueous CaCl₂ (20 g/L) was prepared at room temperature.

Solutions 1 and 2 were combined in various weight ratios, and the total concentration of Kraft lignin and alginate was adjusted by adding water to obtain solutions 4a-e:
Solution 4a: Kraft lignin/alginate 1:2 (2.7 wt. %, pH10.2)
Solution 4b: Kraft lignin/alginate 1:1 (2.7 wt. %, pH10.6)
Solution 4c: Kraft lignin/alginate 2:1 (2.7 wt. %, pH10.7)
Solution 4d: Kraft lignin/alginate 4:1 (2.7 wt. %, pH10.7)
Solution 4e: Kraft lignin/alginate 9:1 (2.7 wt. %, pH10.7)

50 ml of solutions 4a-e were dropped into solution 3 (10× volume) with a pipette. Hydrogel particles 5a-e based on 4a-e formed and settled to the bottom of solution 3.

The hydrogel particles 5a-e were immersed in ethanol (93%, 10× volume) for 5 min. A final solvent exchange step was performed by immersing the gel particles 5a-e from the previous step in pure ethanol (10× volume) for 5 min to obtain alcogel particles 6a-e (final solvent concentration 94-98%).

The alcogel particles 6a-e were dried with supercritical carbon dioxide at 60° C., 120 bar, 1 h to obtain Kraft lignin/alginate hybrid aerogel particles 7a-e. The aerogel particles 7a-e do not smell of Kraft lignin. The aerogel particles 7a-e were used directly for hydrophobization.

### 3.3 Hydrophobic Kraft Lignin/Alginate Hybrid Aerogel—Various Ratios

50 ml hydrophilic lignin aerogel particles 7a-e from previous example 3.2 were placed in a filter bag in a 2 l reactor. 50 ml HMDZ were also placed in the reactor in a small, open container. The reactor was closed and heated to 115° C. After 20 h, the reactor was cooled down to room temperature, and hydrophobic aerogel particles 8a-e were removed from the reactor.

Density of aerogel particles 8a-e was in the range of 45 g/l.

Surface area of aerogel particles 8a-e was measured (description). Hydrophobicity was tested by placing aerogel particles 8a-e on top of water in a container and observing color change (when taking up water, color changes from light brown to dark brown) and shrinkage.

8a: Surface area 429 m²/g. Aerogel particles change color from light brown to dark brown immediately when placed onto water (taking up water), shrinkage by ˜50% within ˜10 s.

8b: Surface area 394 m²/g. Aerogel particles change color from light brown to dark brown immediately when placed onto water (taking up water), shrinkage by ˜50% within ˜30 s.

8c: Surface area 372 m²/g. Aerogel particles shrink by ˜50% within ˜10 min when placed onto water, particles change color from light brown to dark brown (taking up water) over 1 h.

8d: Surface area 330 m²/g. Aerogel particles shrink by ˜50% within ˜2 h when placed onto water, particles change color from light brown to dark brown (taking up water) over ˜4 h.

8e: Surface area 318 m²/g. Aerogel particles shrink by ˜50% within ˜4 h when placed onto water, particles change color from light brown to dark brown (taking up water) over ˜8 h.

### 3.4 Hydrophilic Lignosulfonate/Xanthan Hybrid Aerogel

Solution 1: Lignosulfonate powder was dispersed in deionized water (40 wt. %) at room temperature, and 5 wt. % NaOH was added until a pH of 13 was obtained.
Solution 2: Xanthan was dispersed in the same volume of ethanol and then dissolved in water at room temperature at 0.7 wt %.
Solution 3: Aqueous CaCl₂ (10 g/L) was prepared at room temperature.

Solutions 1 and 2 were combined at a weight ratio of lignosulfonate and xanthan 95:5 to obtain solution 4.

Solution 4 was dropped into solution 3 (10× volume) with a pipette. Hydrogel particles formed and settled to the bottom of solution 3.

The hydrogel particles were immersed in ethanol (93%, 10× volume) for 5 min. A final solvent exchange step was performed by immersing the gel particles from the previous step in pure ethanol (10× volume) for 5 min to obtain alcogel particles (final solvent concentration 94-98%).

The alcogel particles were dried with supercritical carbon dioxide at 60° C., 120 bar, 1 h to obtain lignosulfonate/xanthan hybrid aerogel particles.

Density of the aerogel particles was ˜200 g/l.

Surface area of the aerogel particles was determined to be 290 m²/g.

### 3.5 Hydrophilic Kraft Lignin/Xanthan Hybrid Aerogel

Solution 1: Kraft lignin powder was dispersed in deionized water (20 wt. %) at room temperature, and 5 wt. % NaOH was added until a pH of 13.5 was obtained.
Solution 2: Xanthan was dispersed in the same volume of ethanol and then dissolved in water at room temperature at 0.7 wt %.
Solution 3: Aqueous CaCl₂ (10 g/L) was prepared at room temperature.

Solutions 1 and 2 were combined at a weight ratio of Kraft lignin and xanthan 97:3 to obtain solution 4.

Solution 4 was dropped into solution 3 (10× volume) with a pipette. Hydrogel particles formed and settled to the bottom of solution 3.

The hydrogel particles were immersed in ethanol (93%, 10× volume) for 5 min. A final solvent exchange step was performed by immersing the gel particles from the previous step in pure ethanol (10× volume) for 5 min to obtain alcogel particles (final solvent concentration 94-98%).

The alcogel particles were dried with supercritical carbon dioxide at 60° C., 120 bar, 1 h to obtain Kraft lignin/xanthan hybrid aerogel particles.

Density of aerogel particles was ˜200 g/l.

Surface area of aerogel particles was determined to be 416 m²/g.

### 3.6 Hybrid Aerogels With More Than Two Components

Solution 1: Kraft lignin powder was dispersed in deionized water (14 wt. %) at room temperature, and 5 wt. % NaOH was added until a pH of 10 was obtained. Ludox SM30 (colloidal silica) was added and sodium alginate was added and dissolved in various ratios, the concentration was adjusted with water to obtain various solutions 1 as shown in Table 1.
Solution 2: Aqueous CaCl₂ (10 g/L) was prepared at room temperature and adjusted to pH10 with 1M NaOH.

Solution 1 was dropped into solution 2 (10× volume) with a pipette. Hydrogel particles formed and settled to the bottom of solution 2.

The hydrogel particles were immersed in ethanol (93%, 10× volume) for 5 min. A final solvent exchange step was performed by immersing the gel particles from the previous step in pure ethanol (10× volume) for 5 min to obtain alcogel particles (final solvent concentration 94-98%).

The alcogel particles were dried with supercritical carbon dioxide at 60° C., 120 bar, 1 h to obtain colloidal silica/Kraft lignin/alginate hybrid aerogel particles as shown in Table 1.

TABLE 1

| | | | | | | | Aerogel | Aerogel |
|---|---|---|---|---|---|---|---|---|
| | | | | | | Regular | bulk | surface |
| | | | | | | bead | density | area |
| C1-1 | wt. % | C1-2 | wt. % | C2 | wt. % | shape | g/l | m²/g |
| Ludox | 2.2% | Kraft | 6.8% | Na | 1.0% | Yes | ~90 | 257 |
| SM30 | | Lignin | | alginate | | | | |
| Ludox | 4.5% | Kraft | 4.5% | Na- | 1.0% | Yes | ~90 | 267 |
| SM30 | | Lignin | | alginate | | | | |
| Ludox | 6.8% | Kraft | 2.2% | Na | 1.0% | Yes | ~90 | 278 |
| SM30 | | Lignin | | alginate | | | | |

### 3.7 Hybrid Aerogels With Various Biopolymers

Solution 1: tannic acid, was blended with 2 wt. % sodium alginate solution to obtain various solutions with concentration and weight ratio as shown in Table 2. 40 wt. % NaOH was added to various solutions until the pH shown in Table 2 was obtained.
Solution 2: Aqueous CaCl₂ (10 g/L) was prepared at room temperature and adjusted to pH10 with 1M NaOH.

Solution 1 was dropped into solution 2 (10× volume) with a pipette. Hydrogel particles formed and settled to the bottom of solution 2.

The hydrogel particles were immersed in ethanol (93%, 10× volume) for 5 min. A final solvent exchange step was performed by immersing the gel particles from the previous step in pure ethanol (10× volume) for 5 min to obtain alcogel particles (final solvent concentration 94-98%).

The alcogel particles were dried with supercritical carbon dioxide at 60° C., 120 bar, 1h to obtain hydrophilic hybrid aerogel particles with bulk density and surface area as shown in Table 2.

For hydrophobization, 50 ml hydrophilic aerogel particles were placed in a filter bag in a 2 l reactor. 50 ml HMDZ were also placed in the reactor in a small, open container.

The reactor was closed and heated to 115° C. After 20 h, the reactor was cooled down to room temperature, and hydrophobic aerogel particles with a surface area as shown in Table 2 were removed from the reactor.

TABLE 2

| | | | | | Aerogel | Aerogel | |
|---|---|---|---|---|---|---|---|
| | | | | | bulk | surface | Aerogel surface area |
| | | | | | density | area | after hydrophobization |
| C1 | wt. % | C2 | wt. % | pH | g/l | m²/g | m²/g |
| Tannic | 5.9% | Na | 1.0% | 11.5 | 85 | 128 | 110 |
| acid | | alginate | | | | | |

### 4. Methods Used

4.1 Pore volume was measured according to DIN 66134:1998-02 using a Nova 4000e pore size analyzer from Quantachrome Instruments. Approximately 15-20 mg of the samples were broken off from the original sample and placed in a measuring glass cell. The samples were degassed under 50 mm Hg vacuum and 60° C. for 15 h to remove any adsorbed components on the sample. The samples were weighed again prior to the surface area and pore size analysis.
4.2 Surface area measurements: Specific surface area was determined by Brunauer-Emmet-Teller (BET) method using low-temperature nitrogen adsorption analysis (at the boiling point of nitrogen, 77K) between the IUPAC recommended P/P0 range (0.05-0.30). The 1/ ((w. (P0/P-1))) vs P/P0 graph yielded linear plot with correlation coefficients (r) above 0.999.
   Literature cited:
U.S. Pat. No. 2,019,0329208A1
Grishechko, L. et al. Industrial Crops and Products 2013, 41 347-355
WO 2009/027310
Robitzer et al. Langmuir 2008, 24, 12547-12552
WO 2009/027310

1. A process for preparing a porous material, the process at least comprising:
a) providing a mixture (M1) comprising a water-soluble bio-based polyphenolic polymer selected from the group consisting of lignin biopolymers and tannin biopolymers as compound (C1) and water,
b) bringing mixture (M1) into contact with an aqueous solution of at least one polyvalent metal ion to prepare a gel (A),
c) exposing the gel (A) obtained in b) to a water-miscible solvent (L) to obtain a gel (B), and
d) drying of the gel (B) obtained in c).

2. The process according to claim 1, wherein the mixture (M1) further comprises at least one water-soluble polysaccharide with carboxylic acid groups as compound (C2).

3. The process according to claim 1, wherein the water-soluble bio-based polyphenolic polymer is selected from the group consisting of alkali lignin, Kraft lignin, hydrolytic lignin, soda lignin, aquasolv solid lignin, enzymatic lignin, lignin sulfonate, lignin carboxylate, lignin derivatives, biorefinery lignin, tannic acid, and tannin and tannin derivatives.

4. The process according to claim 1, wherein mixture (M1) comprises the bio-based polyphenolic polymer in an amount of 0.1% by weight to 50% by weight based on a weight of mixture (M1).

5. The process according to claim 1, wherein mixture (M1) comprises compound (C1) and compound (C2) in a ratio in a range of from 55:45 to 98:2.

6. The process according to claim 1, wherein a pH value of mixture (M1) is in a range of 8 to 14.

7. The process according to claim 1, wherein the polyvalent metal ion is a divalent or trivalent metal ion.

8. The process according to claim 1, wherein the process comprises further at least one modification of the dried gel.

9. The process according to claim 8, wherein the modification is selected from the group consisting of shaping, compression, lamination, post-drying, hydrophobization, and carbonization.

10. The process according to claim 1, wherein the solvent (L) used in c) is selected from the group consisting of C₁-C₆ alcohols, C₁-C₆ ketones and mixtures thereof.

11. The process according to claim 1, wherein
a water insoluble solid (S) and/or
a compound (C) selected from the group consisting of pigments, opacifiers, flame retardants, catalytic materials, metals, metal oxides, metal sulfides, metal carbides, metal salts, silicon-based materials, carbon-based materials, metal-organic frameworks, semiconductors, sulfur, fillers, surface-active substances, heat control member, fibers and foam reinforcement,
is added to mixture (M1).

12. A porous material, which is obtained or obtainable by the process according to claim 1.

13. The porous material according to claim 12, wherein a specific surface area of the porous material is in a range of from 120 to 800 m²/g, determined using a BET theory according to DIN 66134:1998-0 and a pore volume is in a range of from 2.1 to 9.5 cm³/g for pore sizes <150 nm.

14. The porous material according to claim 12, wherein a content of volatile organic compounds (VOC) in the porous material is less than 50% of a content of volatile organic compounds (VOC) in the bio-based polyphenolic polymer used in the process.

15. The porous material according to claim 12, wherein the porous material is a component of at least one article selected from the group consisting of thermal insulation material, carrier material for load and release of actives, battery applications, electrode materials in batteries, fuels cells or electrolysis, catalysis, capacitors, consumer electronics, building and construction applications, home and commercial appliance applications, temperature-controlled logistics applications, vacuum insulation applications, apparel applications, food applications, cosmetic applications, biomedical applications, agricultural applications, consumer applications, packaging applications or pharmaceutical application.

16. The process according to claim 7, wherein the polyvalent metal ion is a divalent or trivalent metal ion selected from the group consisting of earth alkali metal ions, aluminum ions and iron (III) ions.
